(19) United States
(12) Patent Application Publication
(10) Pub. No.: US 2014/0321163 A1
(43) Pub. Date: Oct. 30, 2014

(54) LIGHT GUIDE DEVICE AND BACKLIGHT MODULE CONTAINING THE SAME

(71) Applicant: Radiant Opto-Electronics Corporation, Kaohsiung City (TW)

(72) Inventors: Pei-Ling KAO, Kaohsiung City (TW); Hsueh-Ju CHEN, Kaohsiung City (TW); Ting-Ting HU, Kaohsiung City (TW)

(73) Assignee: Radiant Opto-Electronics Corporation, Kaohsiung City (TW)

(21) Appl. No.: 14/149,316

(22) Filed: Jan. 7, 2014

(30) Foreign Application Priority Data
Apr. 30, 2013 (TW) 102115432

(51) Int. Cl. F21V 8/00

(52) U.S. Cl. CPC G02B 6/0036
USPC 362/619

(57) ABSTRACT

A light guide device includes a light guide plate and a reflector. The light guide plate includes a light transmissive body with opposite first and second surfaces, and a plurality of first and second light guide structures extending along a first direction. The first light guide structures are disposed on the first surface, and the second light guide structures are disposed on the second surface. The reflector includes a reflector body and a plurality of reflecting structures formed on the reflector body and extending along a second direction. The first and second directions are perpendicular to each other. The reflecting structures are formed on one side of the reflector body facing the first surface.

### CROSS-REFERENCE TO RELATED APPLICATION

This application claims priority of Taiwanese Application No. 102115432, filed on Apr. 30, 2013.

### BACKGROUND OF THE INVENTION

1. Field of the Invention

This invention relates to a light-emitting device, more particularly to a light guide device and a backlight module containing the same.

2. Description of the Related Art

In recent years, liquid-crystal televisions have grown in popularity due to technological advancement and higher income. However, the liquid crystals in the liquid-crystal television cannot emit light, so that a backlight module is required to serve as a light source for the liquid-crystal television.

Referring to FIG. 1, a conventional edge-type backlight module includes a light source 11 that emits light, a light guide plate 12 to guide the light from the light source 11, a reflector 13 that is disposed under the light guide plate 12 to reflect the light, and an optical film 14 that is disposed on the light guide plate 12. The light guide plate 12 has a plurality of protrusions 121 that protrude toward the reflector 13, and a light incident surface 122 that faces the light source 11.

In the conventional backlight module, the enhanced luminance and brightness attributed to the protrusions 121 are still insufficient, and optical interference and adsorption phenomenon between the light guide plate 12 and the reflector 13 may occur.

### SUMMARY OF THE INVENTION

Therefore, the object of the present invention is to provide a light guide device and a backlight module that may overcome the aforesaid drawbacks associated with the prior art.

According to a first aspect of this invention, there is provided a light guide device including a light guide plate and a reflector. The light guide plate includes a light transmissive body with opposite first and second surfaces and a plurality of first and second light guide structures formed on the light transmissive body and extending along a first direction. The first light guide structures are disposed on the first surface of the light transmissive body, and the second light guide structures are disposed on the second surface of the light transmissive body. The reflector is in contact with the light guide plate and includes a reflector body and a plurality of reflecting structures formed on the reflector body and extending along a second direction. The first and second directions are perpendicular to each other. The reflecting structures are formed on a surface of the reflector body facing the first surface of the light transmissive body and are in contact with the first light guide structures of the light guide plate.

According to a second aspect of this invention, there is provided a backlight module including a light guide device, a light source, and an optical unit. The light guide device includes a light guide plate and a reflector. The light guide plate includes a light transmissive body with opposite first and second surfaces and a plurality of first and second light guide structures formed on the light transmissive body and extending along a first direction. The first light guide structures are disposed on the first surface of the light transmissive body, and the second light guide structures are disposed on the second surface of the light transmissive body. The reflector is in contact with the light guide plate and includes a reflector body and a plurality of first reflecting structures formed on the reflector body and extending along a second direction. The first and second directions are perpendicular to each other. The first reflecting structures are formed on a surface of the reflector body facing the first surface of the light transmissive body and are in contact with the first light guide structures of the light guide plate. The light source emits light toward the light guide device. The optical unit is in contact with the light guide plate of the light guide device oppositely of the reflector.

With the light guide structures and the reflecting structures perpendicular to the light guide structures, the contact area between the light guide plate 3 and the reflector 4 may be significantly reduced so as to minimize optical interference and alleviate adsorption between the light guide plate 3 and the reflector 4. The contact area can be further reduced by controlling the heights of the light guide structures and the reflecting structures. Moreover, with the light guide structures formed on two opposite surfaces (i.e., first and second surfaces 311, 313) of the light transmissive body 31 and extending along the same direction (first direction, X), the light collection efficiency of the light emitted from the light source 5 may be enhanced so as to increase the luminance and brightness of the light guide device 2.

### BRIEF DESCRIPTION OF THE DRAWINGS

Other features and advantages of the present invention will become apparent in the following detailed description of the preferred embodiments with reference to the accompanying drawings:

FIG. 1 is a schematic diagram showing a conventional edge type backlight module;

FIG. 2 is an exploded perspective view of the first preferred embodiment of a light guide device according to this invention;

FIG. 3 is a fragmentary partly cross-sectional view of the first preferred embodiment;

FIG. 4 is another fragmentary partly cross-sectional view of the first preferred embodiment;

FIG. 5 is an exploded perspective view of the second preferred embodiment of a light guide device according to this invention;

FIG. 6 is a fragmentary partly cross-sectional view of the second preferred embodiment;

FIG. 7 is another fragmentary partly cross-sectional view of the second preferred embodiment; and

FIG. 8 is a partly cross-sectional view of the preferred embodiment of a backlight module according to this invention.

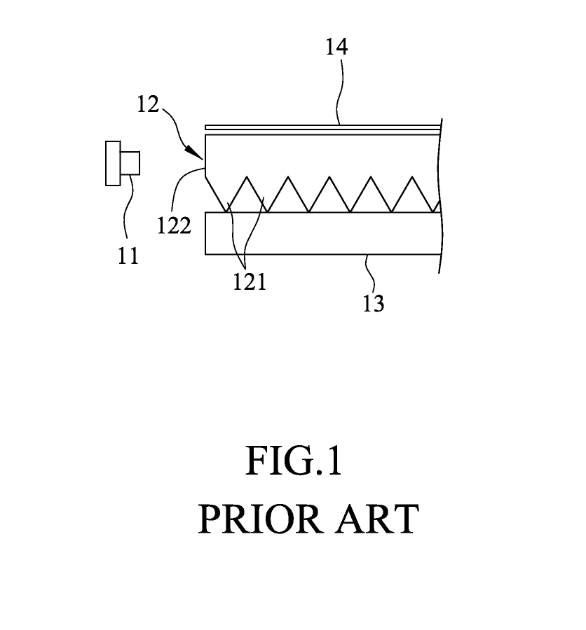

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

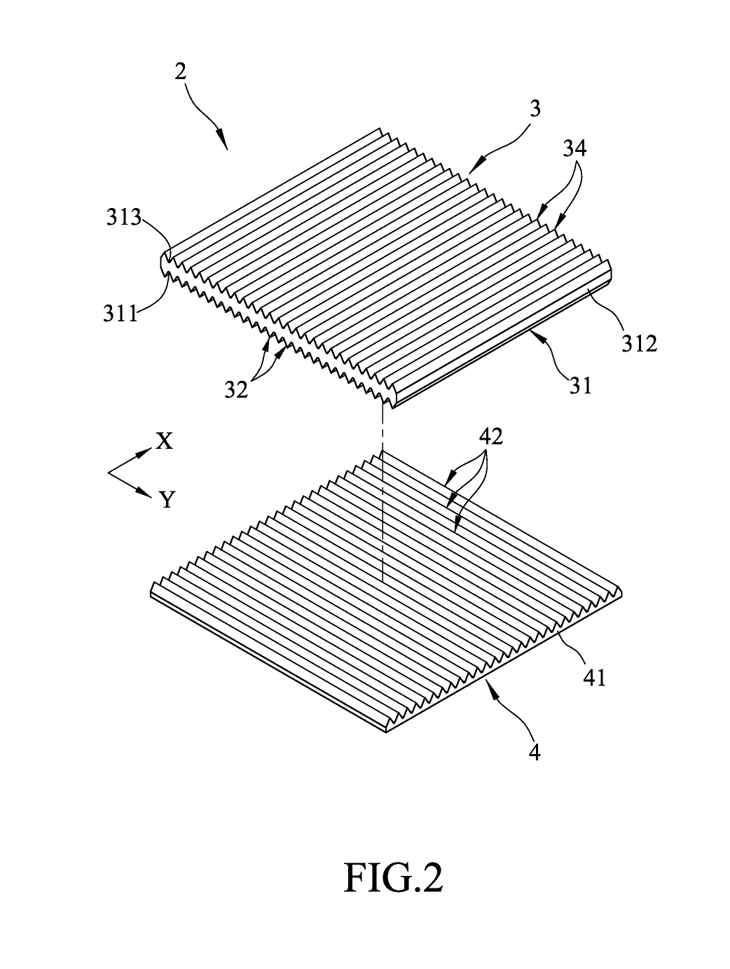

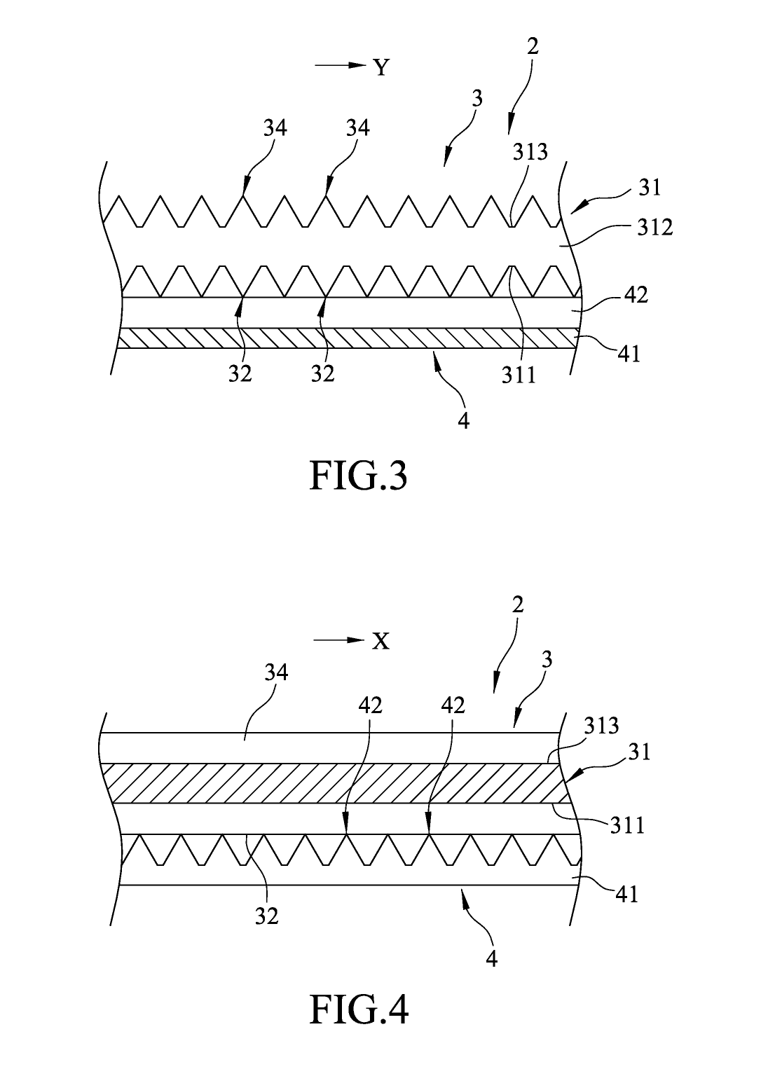

Referring to FIGS. 2, 3, and 4, the first preferred embodiment of a light guide device 2 according to this invention includes a light guide plate 3 and a reflector 4. The light guide plate 3 includes a light transmissive body 31 with opposite first and second surfaces 311, 313, and a plurality of first and second light guide structures 32, 34 formed on the light transmissive body 31 and extending along a first direction (X). In this embodiment, the first and second surfaces 311, 313 are light exiting surfaces. The light transmissive body 31 has a surrounding surface 312 surrounding and interconnecting peripheries of the first and second surfaces 311, 313. The first light guide structures 32 are disposed on and tapered from the first surface 311 of the light transmissive body 31, and the second light guide structures 34 are disposed on and tapered from the second surface 313 of the light transmissive body 31.

The reflector 4 is in contact with the light guide plate 3 and includes a reflector body 41 and a plurality of first reflecting structures 42 formed on and tapered from the reflector body 41 and extending along a second direction (Y). The first and second directions (X, Y) are perpendicular to each other. The first reflecting structures 42 are formed on a surface of the reflector body 41 facing the first surface 311 of the light transmissive body 31 and are in contact with the first light guide structures 32 of the light guide plate 3.

The first and second light guide structures 32, 34, are capable of increasing light collection efficiency so as to improve luminance and brightness of the light guide device 2. With the first reflecting structures 42 extending along the second direction (Y) perpendicular to the first direction (X), a contact area between the first light guide structures 32 and the first reflecting structures 42 can be reduced so that adsorption between the light guide plate 3 and the reflector 4 could be alleviated. Meanwhile, optical interference could be decreased.

In addition, the first, second, third, and fourth light guide structures 32, 34, 33, 35 extend in the identical direction so as to improve convenience of assembling the light guide plate 3 and the first and second reflecting structures 42, 43 of the reflector 4 without considering the assembling direction.

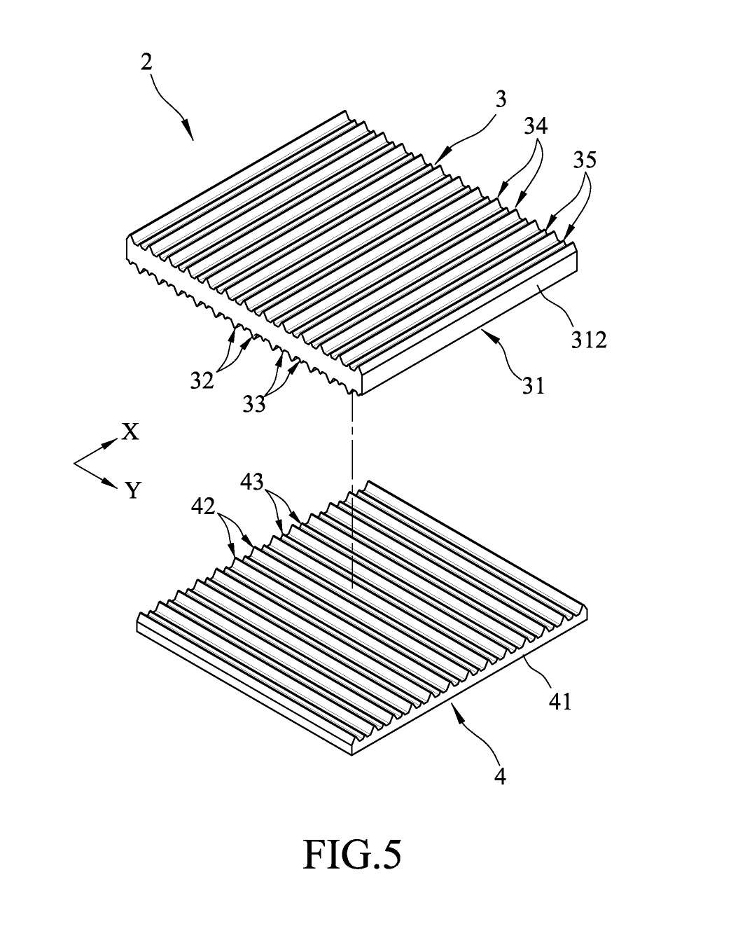

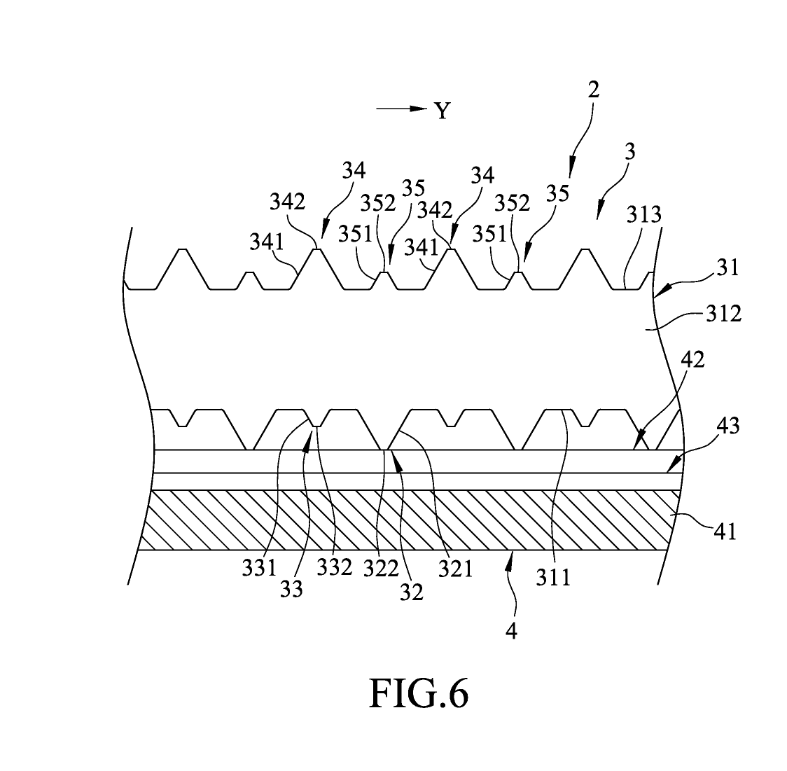

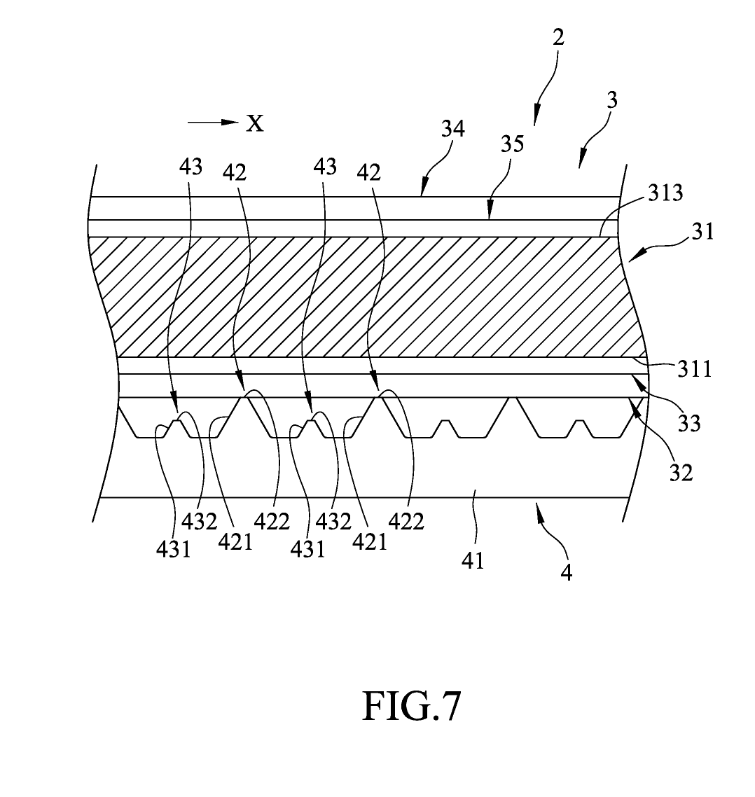

As shown in FIGS. 5, 6, and 7, the second preferred embodiment of the light guide device 2 according to this invention is similar to the first preferred embodiment. The differences between the first and second preferred embodiments reside in that, in the second preferred embodiment, in addition to the first and second light guide structures 32, 34 and the first reflecting structures 42, the light guide plate 3 further includes a plurality of third and fourth light guide structures 33, 35, and the reflector 4 further includes a plurality of second reflecting structures 43. The third and fourth light guide structures 33, 35 are respectively formed on the first and second surfaces 311, 313 of the light transmissive body 31, extend along the first direction (X), and are respectively different from the first and second light guide structures 32, 34 in characteristics. In this invention, the characteristics include height, width, shape, and roughness. Examples of the shape include, but are not limited to V shape, arc shape, and trapezoid shape. Formation of light guide dots or hairline structure may be conducted to change the shape. In this invention, roughness indicates the roughness of the surface of the light guide structure. For example, the surface of the light guide structure may be glossy surface or mat surface. The second reflecting structures 43 are formed on the surface of the reflector body 41 where the first reflecting structures 42 are formed and extend parallel to the first reflecting structures 42 along the second direction (Y).

In this embodiment, the first light, guide structures 32 are not aligned with the second light guide structures 34, and the third light guide structures 33 are not aligned with the fourth light guide structures 35.

In this embodiment, a height of each of the first light guide structures 32 with respect to the first surface 311 of the light transmissive body 31 is different from a height of each of the third light guide structures 33, and a height of each of the second light guide structures 34 with respect to the second surface 313 of the light transmissive body 31 is different from a height of each of the fourth light guide structures 35. To be specific, in this embodiment, the height of each of the first light guide structures 32 is larger than that of each of the third light guide structures 33, and the height of each of the second light guide structures 34 is larger than that of each of the fourth light guide structures 35.

The first and third light guide structures 32, 33 are alternately disposed on the first surface 311 of the light transmissive body 31. Each of the first light guide structures 32 has a first base portion 321 connected to the first surface 311 of the light transmissive body 31 and a first end portion 322 extending from the first base portion 321 oppositely of the light transmissive body 31. Each of the third light guide structures 33 is tapered from the first surface 311 of the light transmissive body 31, and has a third base portion 331 connected to the first surface 311 of the light transmissive body 31 and a third end portion 332 extending from the third base portion 331 oppositely of the light transmissive body 31.

The second and fourth light, guide structures 31, 35 are alternately disposed on the second surface 313 of the light transmissive body 31. Each of the second light guide structures 34 has a second base portion 341 that is connected to the light transmissive body 31, and a second end portion 342 that extends from the second base portion 341 oppositely of the light transmissive body 31. Each of the fourth light guide structures 35 is tapered from the second surface 313 of the light transmissive body 31, and has a fourth base portion 351 that is connected to the light transmissive body 31, and a fourth end portion 352 that extends from the fourth base portion 351 oppositely of the light transmissive body 31.

A height of each of the first reflecting structures 42 with respect to the reflector body 41 is different from a height of each of the second reflecting structures 43. To be specific, in this embodiment, the height of each of the first reflecting structures 42 is larger than that of each of the second reflecting structures 43. The first and second reflecting structures 42, 43 are alternately disposed on the reflector body 41. Each of the first reflecting structures 42 has a first connecting portion 421 connected to the reflector body 41 and a first protrusion portion 422 extending from the first connecting portion 421 oppositely of the reflector body 41. Each of the second reflecting structures 43 is tapered from the reflector body 41 and has a second connecting portion 431 connected to the reflector body 41 and a second protrusion portion 432 extending from the second connecting portion 131 oppositely of the reflector body 41.

Preferably, each of the first, second, third and fourth end portions 322, 342, 332, 352, and the first and second protrusion portions 422, 432 is a truncated end portion. End surfaces of the first, second, third and fourth truncated end portions 322, 342, 332, 352, and those of the first and second truncated protrusion portions 422, 432 may be flat surfaces or curved surfaces. When the first, second, third, and fourth end portions 322, 342, 332, 352 and the first and second truncated protrusion portions 422, 432 are truncated and have no sharp tips, ends of cavities of a mold for forming the light guide structures and the reflecting structures are relatively flat and smooth. Therefore, the flow resistance for a material of the light guide structures and the reflecting structures would be reduced at the ends of the cavities, and the material would flow to the ends of the cavities smoothly, thereby improving the structural precision of the light guide structures and the reflecting structures.

With the height difference between the first and third light guide structures 32, 33, and the height difference between the first and second reflection structures 42, 43, a contact area between the light guide plate 3 and the reflector 4 may be further reduced so as to alleviate adsorption between the light guide plate 3 and the reflector 4 and the optical interference. Furthermore, since the first, second, third, and fourth light guide structures 32, 34, 33, 35 extend along the same direction, when the light guide plate 3 is assembled to the reflector 4, restrictions imposed on assembling direction of the light guide plate 3 may be removed to make assembling more convenient.

In this preferred embodiment, the first, second, third, and fourth light guide structures 32, 34, 33, 35 and the first and second reflecting structures 42, 43 are made by injection molding or thermoforming.

In this preferred embodiment, in addition to the first and second light guide structures 32, 34 and the first reflecting structure 42, the light guide device 2 also includes the third and fourth light guide structures 33, 35 and the second reflecting structure 43. However, in addition to the first and second light guide structures 32, 34 and the first reflecting structures 42, the light guide device 2 can only include one or two of the third light guide structures 33, the fourth light guide structures 35 and the second reflecting structures 43.

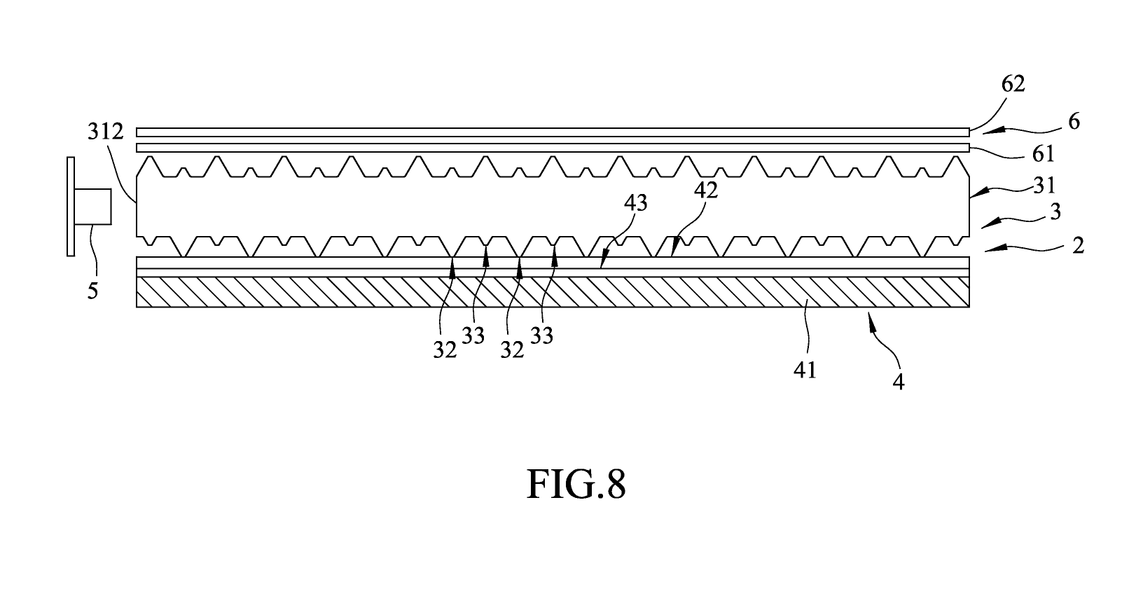

Referring to FIG. 8, the preferred embodiment of a backlight module according to this invention includes a light guide device 2, a light source 5 for emitting light toward the light guide device 2, and an optical unit 6. In this preferred embodiment, the light guide device 2 is that of the second preferred embodiment.

In this preferred embodiment, the backlight module is an edge-type backlight module. A light emitting diode (referred as LED) is used as the light source 5 which is disposed to face the surrounding surface 312 (as a light incident, surface) of the light transmissive body 31 of the light guide plate 3. The optical unit 6 includes a brightness enhancing film 61 and a diffusion film 62. The brightness enhancing film 61 is disposed between the diffusion film 62 and the light guide plate 3. The light source 5 emits light entering into the light transmissive body 31 via the surrounding surface 312.

With the light guide structures and the reflecting structures perpendicular to the light, guide structures, the contact area between the light guide plate 3 and the reflector 4 may be significantly reduced so as to minimize optical interference and alleviate adsorption between the light guide plate 3 and the reflector 4. The contact area can be further reduced by controlling the heights of the light guide structures and the reflecting structures. Moreover, with the light, guide structures formed on two opposite surfaces (i.e., first and second surfaces 311, 313) of the light transmissive body 31 and extending along the same direction (first direction, X), the light collection efficiency of the light emitted from the light source 5 may be enhanced so as to increase the luminance and brightness of the light guide device 2.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A light guide device, comprising:
a light guide plate which includes a light transmissive body with opposite first and second surfaces and a plurality of first and second light guide structures formed on said light transmissive body and extending along a first direction, said first light guide structures being disposed on said first surface of said light transmissive body, said second light guide structures being disposed on said second surface of said light transmissive body; and
a reflector that is in contact with said light guide plate and that includes a reflector body and a plurality of first reflecting structures formed on said reflector body and extending along a second direction, said first and second directions being perpendicular to each other, said first reflecting structures being formed on a surface of said reflector body facing said first surface of said light transmissive body and being in contact with said first light guide structures of said light guide plate.

2. The light guide device as claimed in claim 1, wherein each of said first light guide structures is tapered from said first surface of said light transmissive body and has a base portion connected to said light transmissive body and an end portion extending from said base portion oppositely of said light transmissive body, each of said second light guide structures being tapered from said second surface of said light transmissive body and having a base portion that is connected to said light transmissive body, and an end portion that extends from said base portion oppositely of said light transmissive body.

3. The light guide device as claimed in claim 1, wherein said light guide plate further includes a plurality of third and fourth light guide structures formed on said light transmissive body and extending along the first direction, said third light guide structures being disposed on said first surface of said light transmissive body, said fourth light guide structures being disposed on said second surface of said light transmissive body, said third light guide structures and said first light guide structures being different in characteristics, said fourth light guide structures and said second light guide structures being different in characteristics.

4. The light guide device as claimed in claim 3, wherein each of said first and third light guide structures is tapered from said first surface of said light transmissive body and has a base portion connected to said light transmissive body and a end portion extending from said base portion oppositely of said light transmissive body, each of said second and fourth light guide structures being tapered from said second surface of said light transmissive body, and having a base portion that is connected to said light transmissive body, and a end portion that extends from said base portion oppositely of said light transmissive body.

5. The light guide device as claimed in claim 3, wherein said first and third light guide structures are alternately disposed on said first surface of said light transmissive body.

6. The light guide device as claimed in claim 3, wherein a height of each of said first light guide structures with respect to said first surface of said light transmissive body is different from a height of each of said third light guide structures.

7. The light guide device as claimed in claim 3, wherein said first light guide structures are not aligned with said second light guide structures.

8. The light guide device as claimed in claim 3, wherein said second and fourth light guide structures are alternately disposed on said second surface of said light transmissive body.

9. The light guide device as claimed in claim 3, wherein a height of each of said second light guide structures with respect no said second surface of said light transmissive body is different from a height of each of said fourth light guide structures.

10. The light guide device as claimed in claim 3, wherein said third light guide structures are not aligned with said fourth light guide structures.

11. The light guide device as claimed in claim 1, wherein said reflector further includes a plurality of second reflecting structures formed on said surface of said reflector body where said first reflecting structures are formed and extending parallel to said first reflecting structures along the second direction, a height of each of said first reflecting structures with respect to said reflector body being different from a height of each of said second reflecting structures.

12. The light guide device as claimed in claim 11, wherein each of said first and second reflecting structures is tapered from said reflector body and has a connecting portion connected to said reflector body and a protrusion portion extending from said connecting portion oppositely of said reflector body.

13. A backlight module, comprising:
a light guide device, including
a light guide plate which includes a light transmissive body with opposite first and second surfaces and a plurality of first and second light guide structures formed on said light transmissive body and extending along a first direction, said first light guide structures being disposed on said first surface of said light transmissive body, said second light guide structures being disposed on said second surface of said light transmissive body, and
a reflector that is in contact with said light guide plate and that includes a reflector body and a plurality of first reflecting structures formed on said reflector body and extending along a second direction, said first and second directions being perpendicular to each other, said first reflecting structures being formed on a surface of said reflector body facing said first surface of said light transmissive body and being in contact with said first light guide structures of said light guide plate;
a light source for emitting light toward said light guide device; and
an optical unit in contact with said light guide plate of said light guide device oppositely of said reflector.

14. The backlight module as claimed in claim 13, wherein said light guide plate further includes a plurality of third and fourth light guide structures formed on said light transmissive body and extending along the first direction, said third light guide structures being disposed on said first surface of said light transmissive body, said fourth light guide structures being disposed on said second surface of said light transmissive body, said third light guide structures and said first light guide structures being different in characteristics, said fourth light guide structures and said second light guide structures being different in characteristics.

15. The backlight module as claimed in claim 14, wherein said first and third light guide structures are alternately disposed on said first surface of said light transmissive body.

16. The backlight module as claimed in claim 14, wherein a height of each of said first light guide structures with respect to said first surface of said light transmissive body is different from a height of each of said third light guide structures.

17. The backlight module as claimed in claim 14, wherein said first light guide structures are not aligned with said second light guide structures.

18. The backlight module as claimed in claim 14, wherein said second and fourth light guide structures are alternately disposed on said second surface of said light transmissive body.

19. The backlight module as claimed in claim 14, wherein a height of each of said second light guide structures with respect to said second surface of said light transmissive body is different from a height of each of said fourth light guide structures.

20. The backlight module as claimed in claim 14, wherein said third light guide structures are not aligned, with said fourth light guide structures.

21. The backlight module as claimed in claim 13, wherein said reflector further includes a plurality of second reflecting structures formed on said surface of said reflector body where said first reflecting structures are formed and extending parallel to said first reflecting structures along the second direction, a height of each of said first reflecting structures with respect to said reflector body is different from a height of each of said second reflecting structures.
